(19) United States
(12) Patent Application Publication
(10) Pub. No.: US 2006/0190682 A1
(43) Pub. Date: Aug. 24, 2006

(54) Storage system, method for processing, and program

(75) Inventors: Yasuo Noguchi, Kawasaki (JP); Kazutaka Ogihara, Kawasaki (JP); Seiji Toda, Kawasaki (JP); Mitsuhiko Ohta, Kawasaki (JP); Riichiro Take, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/138,267

(22) Filed: May 27, 2005

(30) Foreign Application Priority Data
Feb. 18, 2005 (JP) 2005-041688

(51) Int. Cl. G06F 12/16

(52) U.S. Cl. 711/114

(57) ABSTRACT

In a storage system, a plurality of RAID devices are connected to a network, and data is multiplexed to primary data and secondary data by being mirrored among the RAID devices. When a failure of a disk device that can be recovered within the devices owing to the RAID configuration occurs, data of a disk device corresponding to the failed disk device is requested to a RAID device that is its mirror target and the transferred data is written to a spare disk device for the recovery. At the time of the data recovery, an access right to a group of disk devices constituting RAID and an access right to individual disk devices are exclusively controlled with respect to an input and output of the primary data.

This application is a priority based on prior application No. JP 2005-041688, filed Feb. 18, 2005, in Japan.

### BACKGROUND OF THE INVENTION

1. Field of the Invention

The present invention relates to a storage system, a method for processing, and a program in which a plurality of RAID (redundant array of inexpensive disks) devices connected to a network are multiplexed by mirroring, and more particularly to a storage system, a method for processing, and a program that carry out efficient recovery processing when a RAID device becomes in a degenerate state due to a device failure.

2. Description of the Related Arts

Conventionally, it has been desired in view of improvement and security of business process that data accumulated in a large scale of the order of tera such as electronic filing documents, observation data, and logs can be accumulated in a medium accessible at all times and referred at a high speed. In order to store such data, an inexpensive storage system with a large capacity that is endurable for long storage of data is required. To realize this, a plurality of RAID devices are connected to a network and used as a virtual storage system. Since reliability of a single RAID device in a storage system in a large scale is not sufficient, in addition to the redundancy of the RAID device, mirroring is carried out among the RAIDS via the network, thereby allowing redundancy among the RAID devices.

FIG. 1A represents a conventional RAID multiplexed system. To a network 100 are connected RAID devices 104-1 to 104-4 via personal computers 102-1 to 102-4. In each of the RAID devices 104-1 to 104-4, for example, the RAID level 4 is configured such that a plurality of disk devices 108-1 to 108-4 are connected to a RAID controller 106 as storage device to store data D1 to D3 and a parity P as the RAID device 104-1 in FIG. 2. Note that the parity P is stored in the disk device fixed in the RAID level 4. The numeral 112 represents a spare disk device. Mirroring among the RAID devices in FIG. 1A is carried out such that, for example, when primary data A is stored in the RAID device 104-1, secondary data A with the same contents as the primary data A is stored in the RAID device 104-3 as its mirror target. Further, the RAID devices 104-2 and 104-4 are mirrored to store primary data B and secondary data B, respectively. In a storage system in which mirroring is carried out among RAID devices, and when a node failure occurs, for example, in the RAID device 104-2 as in FIG. 1B, the recovery is possible by writing the secondary data B of the RAID device 104-4 that serves as its mirror target via the network 100 after the recovery.

FIG. 3A represents another storage system in which mirroring is carried out among RAID devices. Each of the storage areas of the RAID devices 104-1 to 104-4 is divided into management units, and mirroring is carried out in a different RAID device for every management unit. For example, primary data A is stored in a management unit of the RAID device 104-1, and its secondary data A with the same contents as that of the primary data A is stored in the RAID device 104-2 that serves as its mirror target corresponding to the RAID device 104-1. In such a storage system, when a node failure occurs, for example, in the RAID device 104-2 as in FIG. 3B, as to the secondary data A that has been lost owing to the failure, the primary data A is read out from the RAID device 104-1 that is its mirror target via the network and written in an empty area of the RAID device 104-3 as copy data A for the recovery. Further, as to the secondary data C that has been lost owing to the failure, the primary data C is read out from the RAID device 104-4 that is its mirror target via the network and written in an empty area of the RAID device 104-1 as copy data for the recovery. On the other hand, when a failure can be recovered within the RAID device, data copy via the network is not performed, and failure recovery specific to the RAID device is carried out. FIG. 4 represents a case in which the disk device 108-2 of the RAID device 104-1 breaks down and is degenerated. In an example of RAID 4, the recovery is carried out by modification of the RAID configuration in which data D0, D2 and parity P are read out by the RAID controller 106 from the normal disk devices 108-1, 108-3, and 108-4, and the lost data D1 is recovered by implementing an exclusive logical OR 110, followed by writing it to the spare disk device 112 and replacing the spare disk device 112 in which the write has been completed with the broken-down disk device 108-2. [Patent document 1] Japanese Patent Application Laid-Open Publication No. 2002-108571

In such a conventional storage system in which mirroring is carried out among RAID devices, when a failure that one of the devices constituting RAID breaks down and that can be recovered in the device, a lost data is recovered in the device by taking advantage of the redundancy of RAID as shown in FIG. 4. However, since the number of inputs and outputs of data becomes large, it takes much time for recovery processing, resulting in that a user is affected on accessing data, for example, delay in access. That is, in the case of FIG. 4, three times of read with respect to the disk devices 108-1, 108-3, 108-4, one time of computation of exclusive logical OR, and further one time of write to the spare disk device 112 are necessary, resulting in a significant number of inputs and outputs. This number of inputs and outputs further increases when the number of disk devices that constitute a RAID increases. A similar problem is raised in a RAID level 5 that distributes parity

### SUMMARY OF THE INVENTION

According to the present invention, there are provide a storage system, a method for processing, and a program that shorten a recovery time by reducing the number of inputs and outputs to recover a failure that can be recovered within RAID devices when mirroring is carried out among the RAID devices.

In the present invention, a storage system in which a plurality of RAID devices are connected to a network and data is multiplexed to primary data and secondary data by being mirrored between the RAID devices.

As to such a storage system, the present invention is characterized by being provided with, in each of the RAID devices, a RAID processing unit (RAID controller) that executes request processing targeting for a plurality of devices (disk devices) that are devices constituting RAID and a spare device, and the devices constituting RAID that store primary data, respectively, in response to a request from a host device, a copy request processing unit that requests data of a device corresponding to a failed device to the RAID device that is its mirror target when a failure of a device that can be recovered within the devices owing to the RAID configuration occurs, and subsequently writes the transferred data to a spare device for the recovery, a copy response processing unit that reads out data of a target device upon receiving a data request from the RAID device that has a failure, and transfers the read data to the requesting source, and an exclusion mechanism that exclusively controls an access right to devices constituting RAID and an access right to individual devices.

Here, when a failed device stores primary data, the copy request processing unit requests its secondary data to a RAID device that is its mirror target and writes the transferred secondary data to a spare device for the recovery. The copy response processing unit reads out the secondary data of the target device and transfers it to the requesting source upon receiving a request of the secondary data from the RAID device that has the failure.

In this case, the exclusion mechanism acquires an exclusive access right to the spare device prior to the request of the secondary data from the copy request processing unit and releases the exclusive access right after the transferred secondary data is written to the spare device.

When a failed device stores secondary data, the copy request processing unit requests its primary data to a RAID device that is its mirror target and writes the transferred primary data to a spare device for the recovery, followed by posting completion of the write. The copy response processing unit reads out the primary data of the target device and transfers it to the requesting source upon receiving the request of the primary data from the RAID device that has the failure.

In this case, upon receiving the request of the primary data from the RAID device that has the failure by the copy response processing unit, the exclusion mechanism acquires an exclusive access right to a device targeted for access, allows the primary data to be read out and transferred. After the transfer, the exclusion mechanism receives a notice of the write completion from the RAID device that has the failure, followed by releasing the exclusive access right.

The RAID device retains mirror configuration information that shows a RAID device to be a mirror target and RAID configuration information that shows a configuration of devices constituting RAID, and the copy request processing unit not only searches a RAID device that is a mirror target from the mirror configuration information but also searches a device corresponding to the failed device from the RAID configuration information and requests data at the time of device failure.

Data is multiplexed by being mirrored in all RAID devices. Data may be multiplexed by changing a mirror target for every management unit in the RAID device. The RAID device is connected under each of node devices configured with a cluster of computers connected to the network.

The present invention provides a method for processing of a storage system in which a plurality of RAID devices are connected to a network and data is multiplexed to primary data and secondary data by being mirrored among the RAID devices.

The method for processing of the present invention is characterized by being provided with;

a step of RAID processing at which request processing is carried out targeting for devices constituting RAID of a plurality of devices that store primary data with respect to a request from a host device;

a step of copy request processing at which, when a failure of a device that can be recovered within the devices owing to the RAID configuration occurs, data of a device corresponding to the failed device is requested to the RAID device that is its mirror target and the transferred data is written to a spare device for the recovery;

a step of copy response processing at which, upon receiving the data request from the RAID device that has the failure, the data of the target device is read out and transferred to the requesting source; and

a step of exclusive control at which an access right to the devices constituting RAID and an access right to individual devices are exclusively controlled.

The present invention provides a program that is executed by computers of the RAID devices, through which a plurality of RAID devices are connected to a network, that allow data to be multiplexed to primary data and secondary data by mirroring among RAID devices.

The program of the present invention is characterized in that the computers of the RAID device are allowed to carry out;

a step of RAID processing at which request processing is carried out targeting for devices constituting RAID of a plurality of devices that store primary data with respect to a request from a host device;

a step of copy request processing at which, when a failure of a device that can be recovered within the devices owing to the RAID configuration occurs, data of a device corresponding to the failed device is requested to the RAID device that is its mirror target and the transferred data is written to a spare device for the recovery;

a step of copy response processing at which, upon receiving the data request from the RAID device that has the failure, the data of the target device is read out and transferred to the requesting source; and

a step of exclusive control at which an access right to devices constituting RAID and an access right to individual devices are exclusively controlled.

The details of the method for processing and the program of the present invention are basically the same as those of the storage system of the present invention. The above and other objects, features, and advantages of the present invention will become more apparent from the following detailed description with reference to the drawings.

According to the present invention, with respect to a device failure that can be recovered within the RAID devices by taking advantage of the redundancy of the RAID configuration, it is possible to reduce the number of times of inputs and outputs for recovery to two times that are read-out from the mirror target and writ in the failure source, shorten the recovery time at the time of failure occurrence, and minimize the influence on access by a user at the time of data recovery by means of reading out data of a device corresponding to the failed device in the RAID device that is its mirror target, and subsequently writing the data to a spare device via the network, i.e., copying the data via the network. Further, when the data of the failed device is recovered by copying it via the network, it is possible to inhibit input and output processing to the device constituting RAID by a user during the recovery and prevent contention for access without fail by acquiring an exclusive access right to the individual devices storing primary data that becomes a target of input and output necessary for copying.

### BRIEF DESCRIPTION OF THE DRAWINGS

FIGS. 1A and 1B are detailed diagrams to explain a conventional storage system in which all RAID devices are mirrored;

FIG. 2 is a detailed diagram to explain the RAID device in FIGS. 1A and 1B;

FIGS. 3A and 3B are detailed diagrams to explain a conventional storage system in which mirror targets vary for every management area in the RAID device;

FIG. 4 is a detailed diagram to explain processing for recovery of data in a broken-down disk device in a conventional RAID device;

FIG. 5 is a block diagram of a storage system according to the present invention;

FIG. 6 is a block diagram of functional configuration of the node device and the RAID device in FIG. 5;

FIG. 7 is a detailed diagram to explain data recovery processing when all RAID devices are mirrored;

FIG. 8 is a time chart of data recovery processing due to occurrence of failure in the node storing primary data in FIG. 7;

FIG. 9 is a time chart of data recovery processing due to occurrence of failure in the node storing secondary data in FIG. 7;

FIG. 10 is a flow chart of copy request processing by the node controller in FIG. 6;

FIGS. 11A and 11B are flow charts of copy response processing by the node controller in FIG. 6;

FIG. 12 is a flow chart of the data request processing at step S4 in FIG. 10;

FIG. 13 is a flow chart of the data write processing at step S5 in FIG. 10;

FIGS. 14A and 14B are detailed diagrams to explain data recovery processing in the storage system of the present invention in which mirror targets vary for every management unit in a RAID device;

FIG. 15 is a flow chart of the copy request processing executed by the node controller in the data recovery processing in FIGS. 14A and 14B;

FIG. 16 is a block diagram of another embodiment of the node device of the present invention using a software RAID module; and

FIG. 17 is a block diagram of still another embodiment of the node device of the present invention using disk devices of a storage area network.

### DETAILED DESCRIPTION OF THE PREFERRED EMBODIMENTS

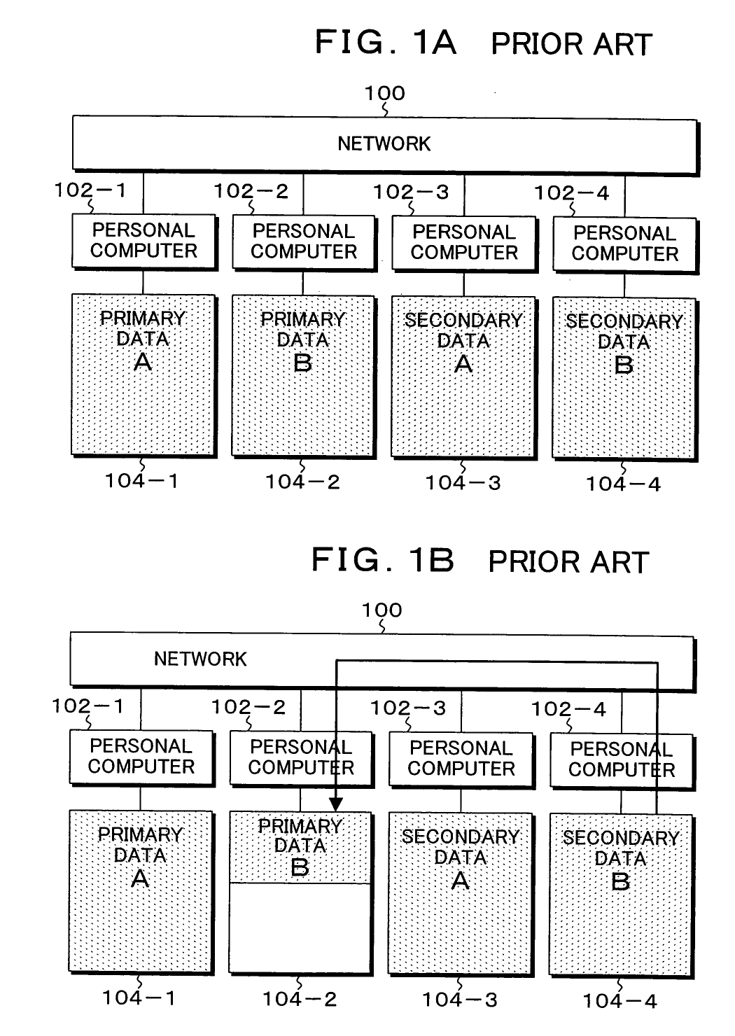

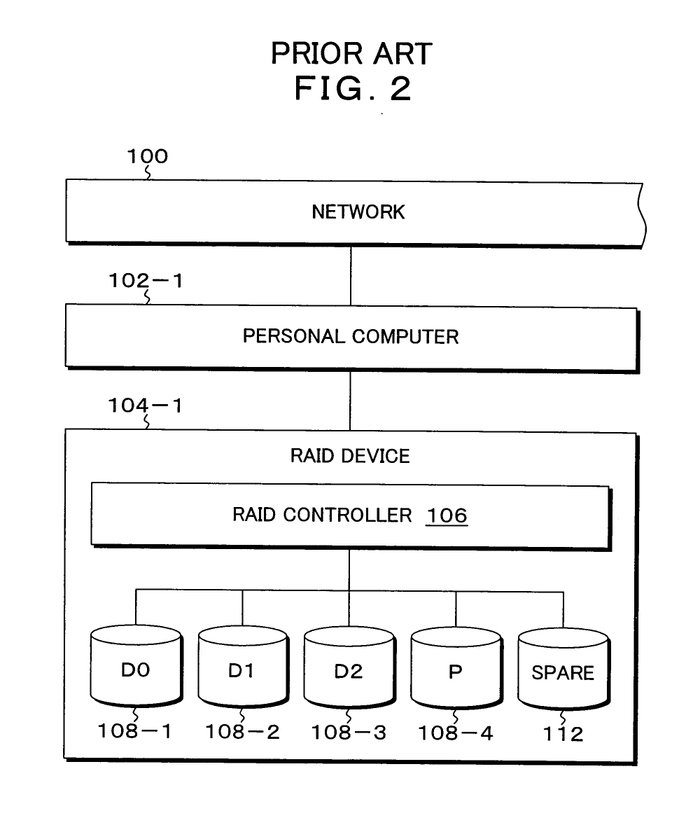

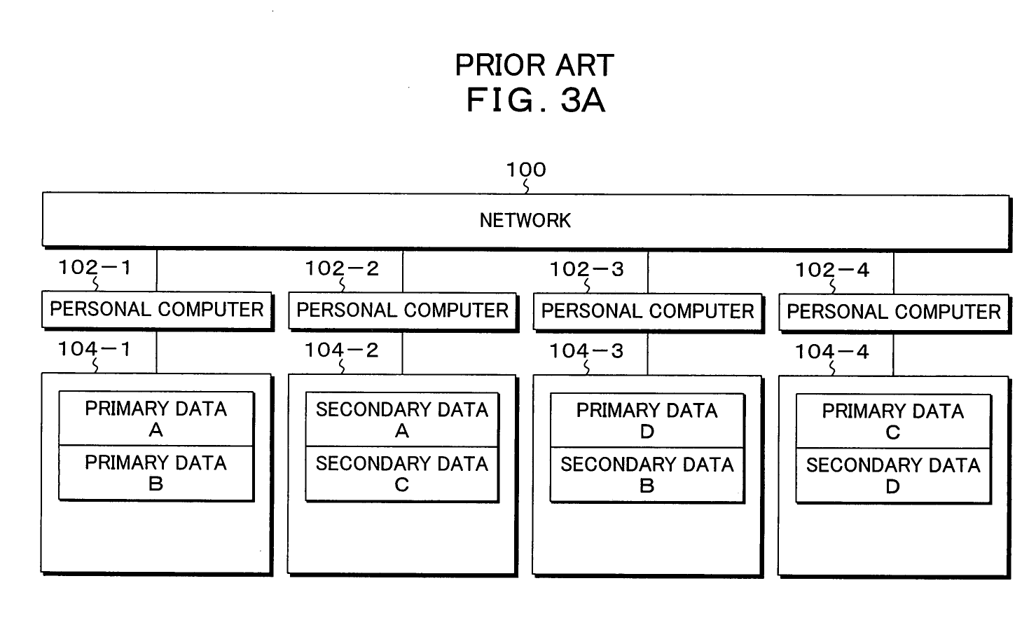

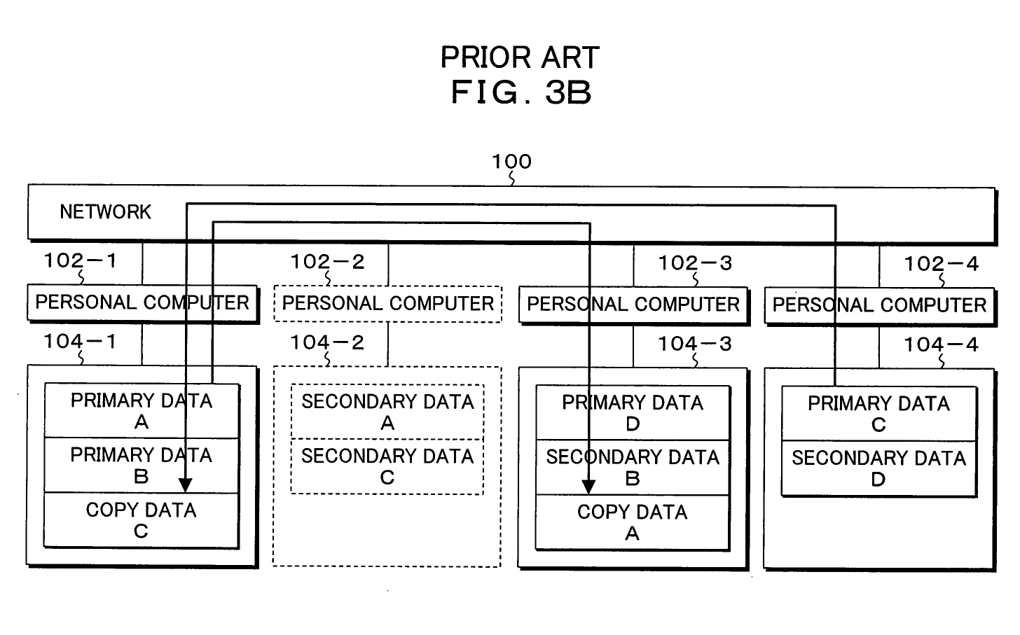

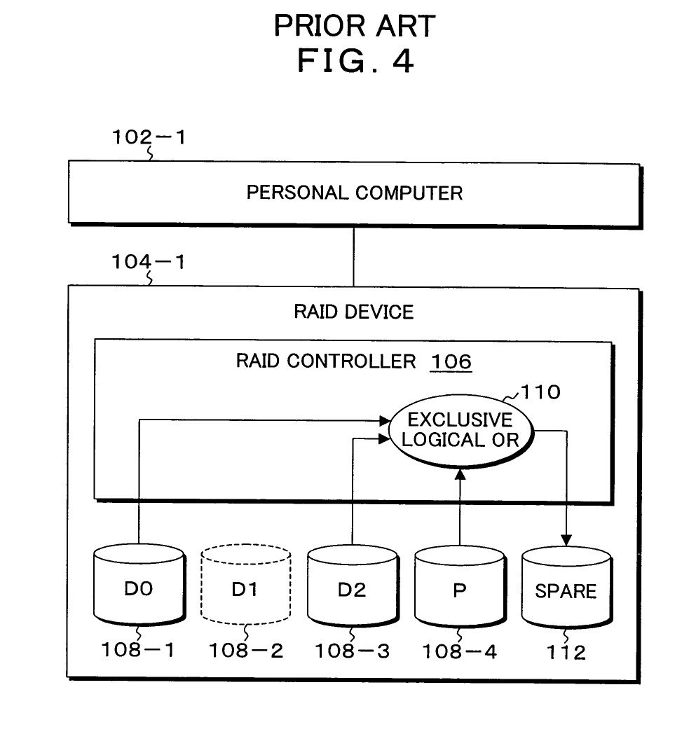

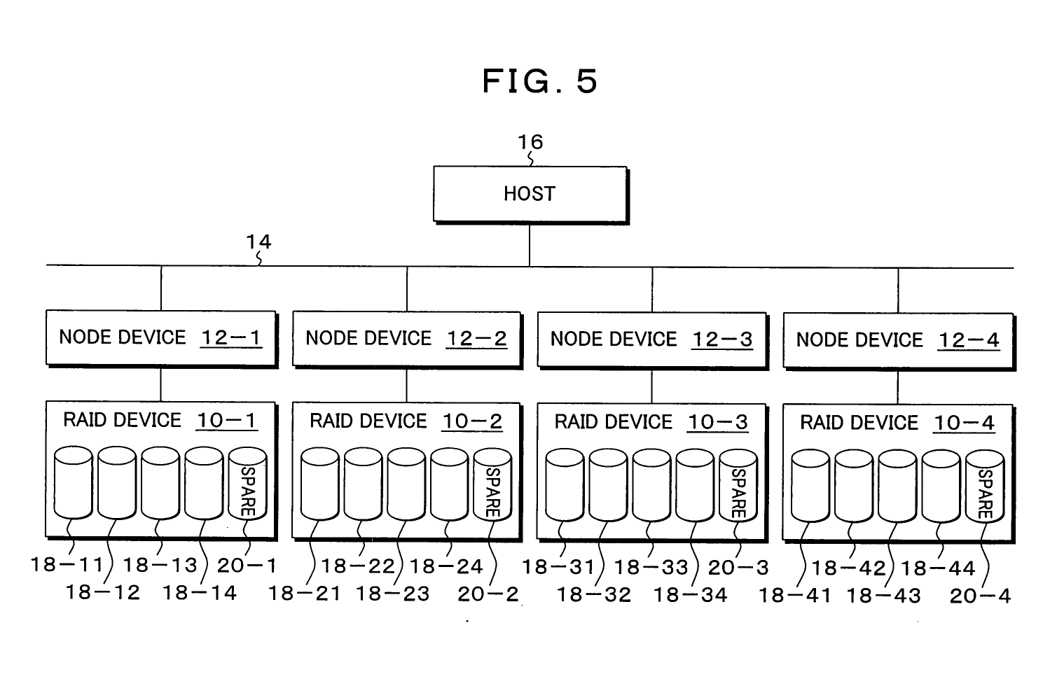

FIG. 5 is a block diagram representing a system configuration of a storage system according to the present invention. In FIG. 5, RAID devices 10-1 to 10-4 are connected to the network 14 via node devices 12-1 to 12-4 and process an input and output request from a host 16 by a user. The node devices 12-1 to 12-4 are configured with personal computers and this group of the computers makes up a cluster system. In the RAID device 10-1, in this example, four disk devices 18-11 to 18-14 are arranged as devices for data, and a spare disk device 20-1 is further arranged. The disk devices 18-11 to 18-14 and the spare disk device 20-1 employ magnetic disk devices. Besides magnetic disk device, disk devices such as optical disk device and semiconductor memory can be appropriately used. The rest of the RAID devices 10-2 to 10-4 are also provided with disk devices 18-21 to 18-24, 18-31 to 18-34, and 18-41 to 18-44 for data, and spare disk devices 20-2 to 20-4, respectively. Data is multiplexed by being mirrored among the RAID devices 10-1 to 10-4. The multiplexing by mirroring among the RAID devices employs either the same configuration in which mirroring is carried out in the all RAID devices as that of the conventional example shown in FIGS. 1A and 1B or mirroring that data is multiplexed by changing a mirror target for every management unit in the RAID device as shown in the conventional example in FIG. 4.

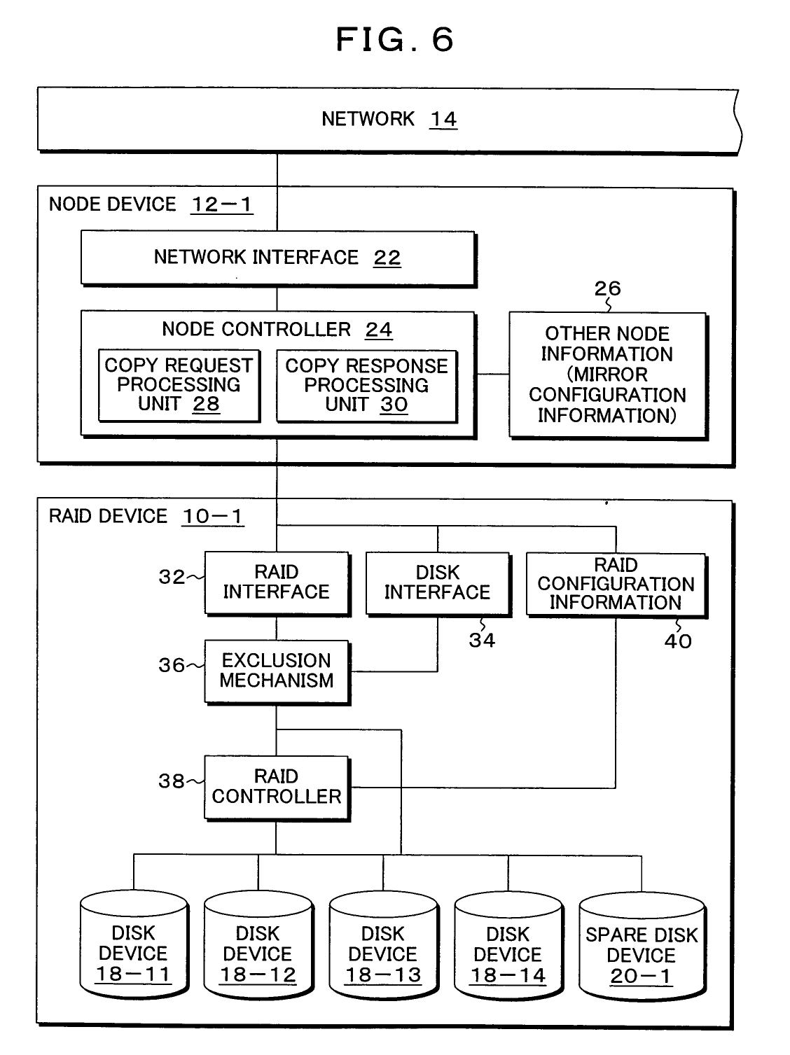

FIG. 6 is a block diagram to represent a functional configuration of the node device 12-1 and the RAID device 10-1 that are provided to the storage system in FIG. 5, and represents a functional configuration in which mirroring is carried out in all RAID devices 10-1 to 10-4 shown in FIG. 5. In FIG. 6, to the node device 12-1 are provided with a network interface 22, a node controller 24, and other node information 26 that functions as mirror configuration information. The node device 12-1 uses specifically a microcomputer. To the node controller 24 are provided the copy request processing unit 28 and the copy response processing unit 30 of the present invention for executing data recovery via a network with respect to a failed device. To the RAID device 10-1 are provided a RAID interface 32, a disk interface 34, an exclusion mechanism 36, a RAID controller 38, and RAID configuration information 40. The functions provided to the RAID interface 32, the RAID controller 38, and the RAID configuration information 40 in the RAID device 10-1 are functions that a conventional RAID device has. In addition to these, the functions of the disk interface 34 and the exclusion mechanism 36 are newly provided to the RAID 10-1 in the present invention. When a failure that any one of the disk devices 18-11 to 18-14 that employ the RAID configuration breaks down occurs, the copy request processing unit 28 provided to the node controller 24 of the node device 12-1 searches a RAID device that is a mirror target from said other node information 26 as mirror configuration information, requests data of a device corresponding to the failed device to the searched RAID device that is the mirror target, and writes the data transferred by the request to the spare disk device 20-1 for the recovery. Upon receiving the data request from the RAID device that has the failure, the copy response processing unit 30 reads out the data of the target disk device, followed by transferring it to the requesting source. The exclusion mechanism 36 exclusively controls an exclusive access right to the disk devices 18-11 to 18-14 as devices constituting RAID by the RAID interface 32 and an exclusive access right to individual disk devices of the disk devices 18-11 to 18-14 and the spare disk device 20-1. Here, in the storage system shown in FIG. 5 in which mirroring is carried out in all of the RAID devices connected to the network, for example, primary data is stored in the RAID device 10-1 by inputs and outputs from the host 16, and secondary data that is the same data as the primary data is stored, for example, in the RAID device 10-3 preset as its mirror target corresponding to the primary data. Owing to this, when the disk devices 18-11 to 18-14 store primary data, respectively, the exclusion mechanism 36 in the RAID device 10-1 in FIG. 6 exclusively controls an access right to the RAID configuration by a user and an access right to individual disks in copy processing at the time of recovery of the failed disk. On the other hand, in a RAID device that has recorded secondary data, for example, the RAID device 10-3 in FIG. 5, there is no need for processing to exclusively control input and output requests for disk devices constituting RAID and individual disk devices because there is no input and output request from the host 16 by a user. With respect to the disk devices 18-11 to 18-14, for example, when the RAID level 4 is exemplified, it is placed on the catalog of the RAID configuration information 40 of the RAID 10-1 that the disk devices 18-11 to 18-13 are data disk devices, the disk device 18-14 is a parity disk device, and the spare device 20-1 exists, and further data stored in the disk devices 18-11 to 18-14 are primary data. The RAID controller 38 processes an input and output request from the network to the RAID interface 32 via the node device 12-1 according to the RAID configuration information 40. On the catalog of said other node information 26 of the node device 12-1 is placed a node address of a mirror target that is mirrored with the RAID 10-1. Here, as to said other node information 26, the node controller 24 may be an interface that inquires node information to node controllers of other nodes via the network interface 22. This feature is applicable to the RAID configuration information 40 in a similar way, and the node controller 24 may also be realized as an interface that inquires RAID configuration information to the RAID controller 38.

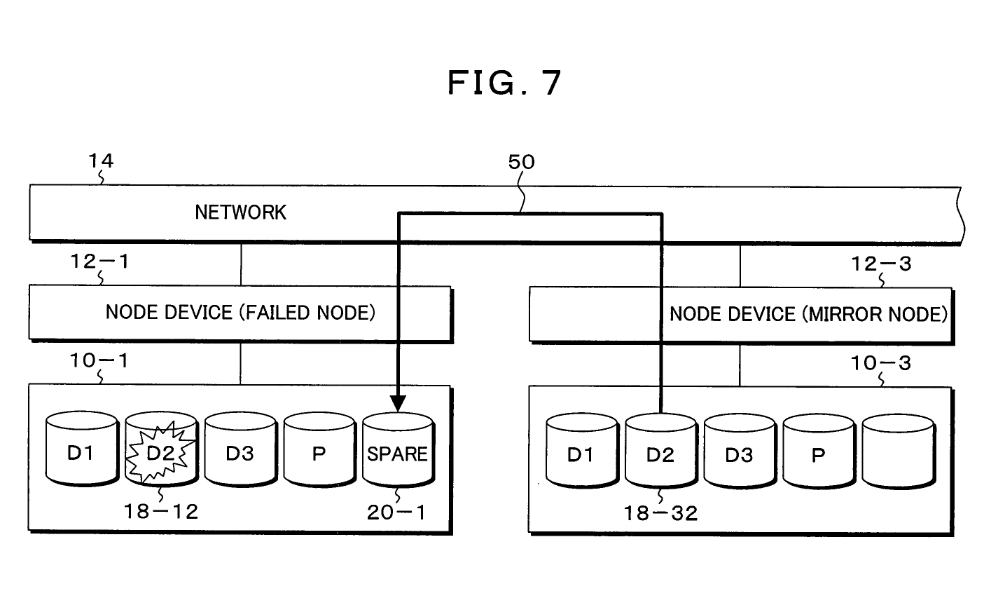

FIG. 7 is a detailed diagram to explain processing in the storage system of the present invention when a failure occurs in a case of mirroring all of the RAID devices. Assuming that a disk device 18-12 of the RAID device 10-1 fails due to, for example, breakdown in FIG. 7, the RAID controller 38 provided to the RAID device 10-1 in FIG. 6 detects the failure of the disk device 18-12 and records it in the RAID configuration information 40, and further posts the failure occurrence to the node controller 24. Upon receiving the failure notice from the RAID device 10-1, the node controller 24 of the node device 12-1 activates the copy request processing unit 28, searches, for example, the node device 12-3 as node information of a mirror target with reference to said other node information 26, and executes a data request from the disk device 18-32 corresponding to the broken-down disk device 18-12 to the node device 12-3. To the data request from the node device 12-1 that has the failure, the node device 12-3 that is the mirror target reads out data from the disk device 18-32 that stores the same data corresponding to that of the failed disk device 18-12, and carries out copy transfer 50 to the node device 12-1 that is the requesting source via the network 14. The node device 12-1 that receives the transferred data read out from the node device 12-3 that is the mirror target writes the read transferred data to the spare disk 20-1 of the RAID device 10-1. When the write of the transferred copied data to the spare disk device 20-1 is completed, in the RAID configuration information 40 provided to the RAID 10-1 in FIG. 6, the RAID configuration information is updated by replacing the failed disk device 18-12 with the spare disk device 20-1 in which the data recovery is completed, thereby terminating the recovery processing. When a failure that can be recovered by making use of the redundancy of the RAID configuration occurs in the RAID devices in which all the RAID devices of the present invention are mirrored in this way, the data is recovered by reading out via the network 14 the data from the disk that is the mirror target corresponding to the failed disk. Accordingly, the input and output processing for data recovery requires one time of data read-out from the disk that is the mirror target and one time of write of the transferred data to a spare disk device that is a recovery target, thereby allowing data recovery processing to be completed with such minimum input and output requests, shortening time to be taken for data recovery, and minimizing influence on input and output request by a user from the host 16 during the data recovery. In the recovery processing of the failure in FIG. 7, the data of the RAID device 10-1 is primary data, and the data of the RAID device 10-3 that is its mirror target is secondary data. In this case, the exclusion mechanism 36 provided to the RAID device 10-1 that stores the primary data has acquired an exclusive access right in order to execute an individual input and output request to the spare disk device 20-1, thereby inhibiting an input and output request from the host 16 to devices constituting RAID during data recovery.

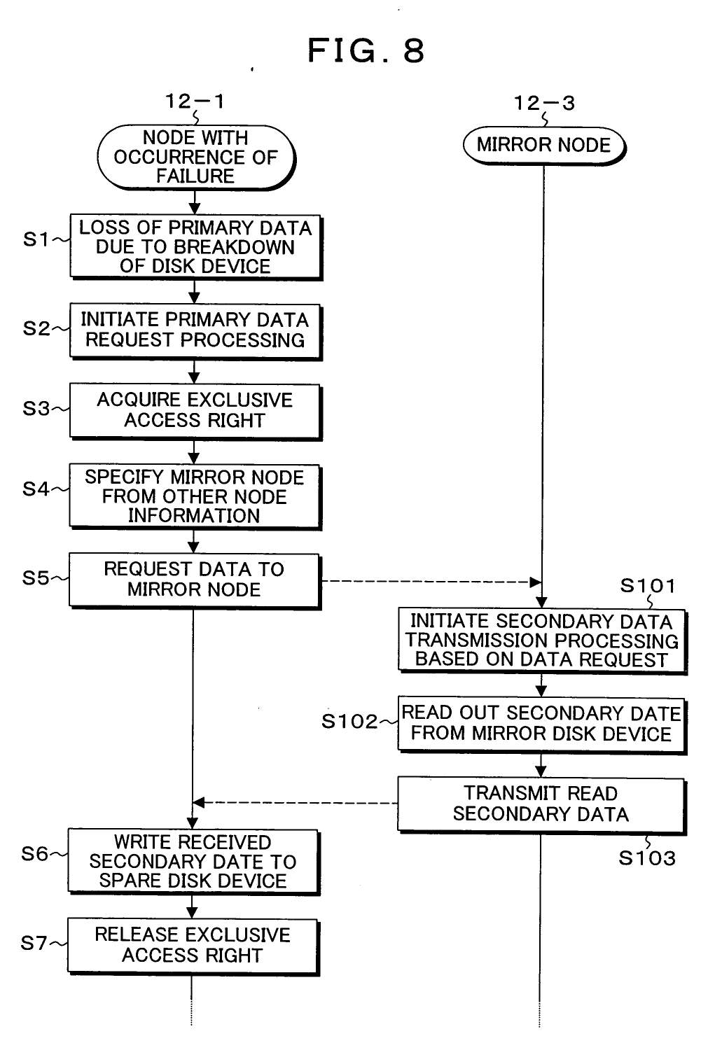

FIG. 8 is a time chart of the recovery processing including interaction between the node 12-1 that is a node with occurrence of failure and the node device 12-3 that serves as its mirror target in a case where a disk device in the RAID device 10-1 storing the primary data shown in FIG. 7 breaks down to lead to a failure occurrence. It should be noted that here, the node device that is a source of failure occurrence is simply represented by the node with occurrence of failure 12-1, and the mirror target is represented by the mirror node 12-3. In FIG. 8, when a loss of primary data that is breakdown of a disk device is recognized at step S1 in the node device with occurrence of failure 12-1, request processing for the primary data is initiated at step S2, and an exclusive access right for individual access to the spare disk device 20-1 is acquired at step S3. Next, the mirror node 12-3 is specified from said other node information 26 at step S4, and a command of data request is transmitted to the mirror node 12-3 at step S5. The mirror node 12-3 initiates secondary data transmission processing based on the command of data request from the node with occurrence of failure 12-1 at step S101. In this secondary data transmission processing, the secondary data is read out from the mirror disk device 18-32 corresponding to the broken-down disk device 18-12 at step S102 and the read-out secondary data is transmitted to the node with occurrence of failure 12-1 via the network 14 at step S103. In the node with occurrence of failure 12-1, the secondary data from the mirror node 12-3 is received and written to the spare disk device 20-1 at step S6, followed by updating the RAID configuration information 40 upon completion of the write. Next, the exclusive access right is released upon completion of the data recovery at step S7, followed by making it possible to access from the host 16 to disk devices constituting RAID.

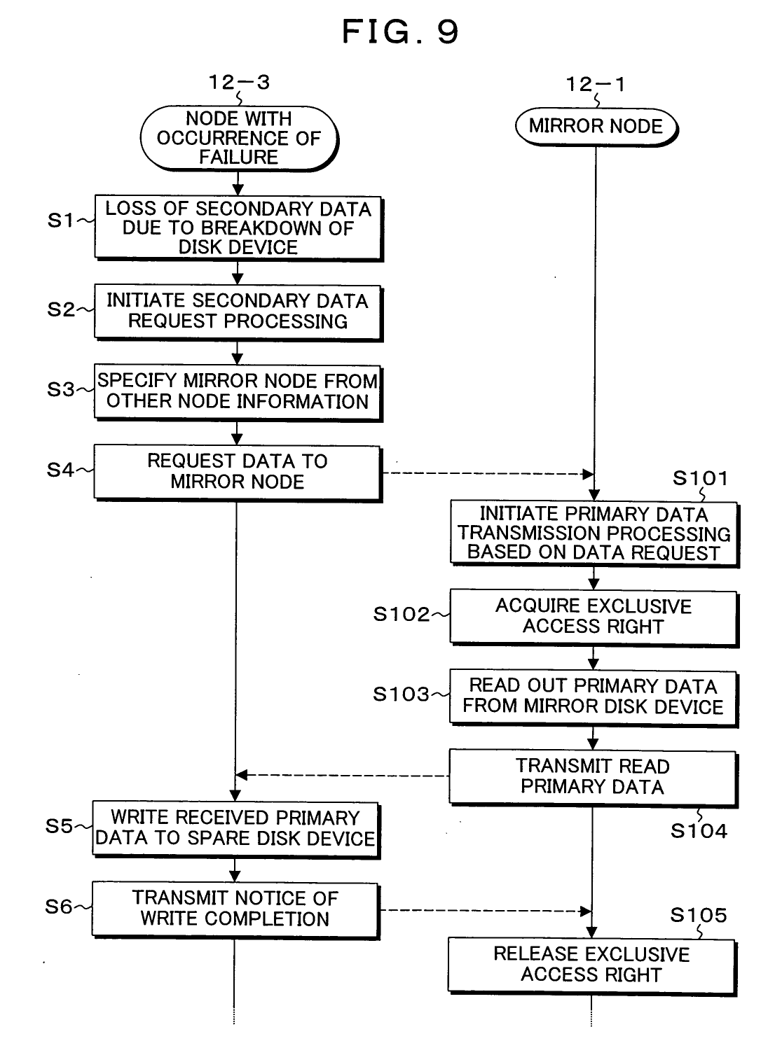

FIG. 9 is a time chart of recovery process when a disk device of the RAID device 10-3 storing the secondary data in FIG. 7 is broken down. The node device 12-3 of the RAID device 10-3 is assumed to be a failed node, and the node device 12-3 of the RAID device 10-1 is assumed to be its mirror node. In FIG. 9, as to the failed node 12-3, a loss of secondary data is detected due to breakdown of a disk device at step S1, and secondary data request processing is initiated at step S2. In this secondary data request processing, the mirror node 12-1 is specified from said other node information 26 at step S3, and a command of data request is transmitted to the mirror node 12-1 at step S4. As to the mirror node 12-1, primary data transmission processing is initiated according to the data request based on the command from the failed node 12-3 at step S101. In this primary data transmission processing, after an exclusive access right to the disk device in the RAID device of the mirror node 12-1 corresponding to the broken-down disk device is acquired at step S102, the primary data is read out of the mirror disk device at step S103, and the primary data read out is transmitted to the node with occurrence of failure 12-3 via the network 14 at step S104. As to the node with occurrence of failure 12-3, the primary data received from the mirror node 12-1 is written to a spare disk device at step S5, and then the RAID configuration information is updated, followed by transmitting a command of notice of the write completion to the mirror node 10-1 at step S6. With respect to the mirror node 12-1, the notice of the write completion is received from the node with occurrence of failure 12-3, and the exclusive access right to the spare disk device acquired at step S102 is released at step S105, followed by making it possible to carry out input and output processing to the mirror node 12-1 from the host 16 by a user.

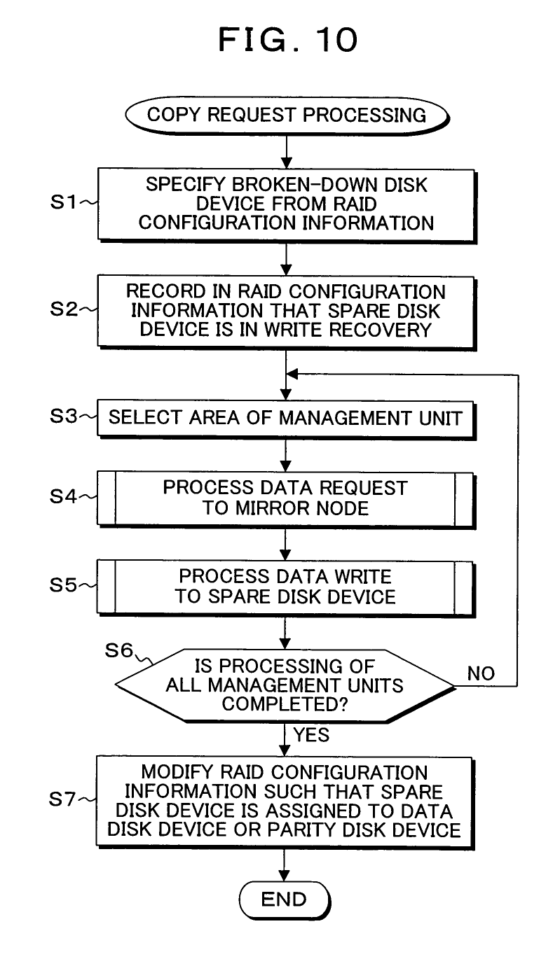

FIG. 10 is a flow chart of copy request processing by the node controller 24 in an embodiment in which all RAID devices shown in FIG. 6 are mirrored. In FIG. 10, the copy request processing by the node controller 24 is initiated by detecting a failure in a disk device by the RAID controller 38 and posting it to the node controller 24. At the beginning of this node processing, the RAID controller 38 records the broken-down disk device in the RAID configuration information 40. When the node processing is initiated in this way, the broken-down disk device is specified from the RAID configuration information 40 at step S1, and then it is recorded in the RAID configuration information 40 at step S2 that the spare disk device 20-1 is in write recovery. Next, at step S3, an area of management unit is selected and data request processing is executed to the mirror node at step S4. Next, write processing in which the copied data transferred from the mirror node is written in the spare disk device 20-1 is carried out at step S5. At step S6, completion or incompletion of the processing of all management units is checked, and processing from the step S3 is repeated until the processing of all management units is completed. When all processing of the management units is finished, the step proceeds to step S7, and the RAID configuration information 40 is modified such that the spare disk device 20-1 is assigned as a data disk device or a parity disk device, thereby completing the series of processing. The data request processing at step S4 and the data write processing at step S5 in the copy request processing in FIG. 10 are explained in more detail later.

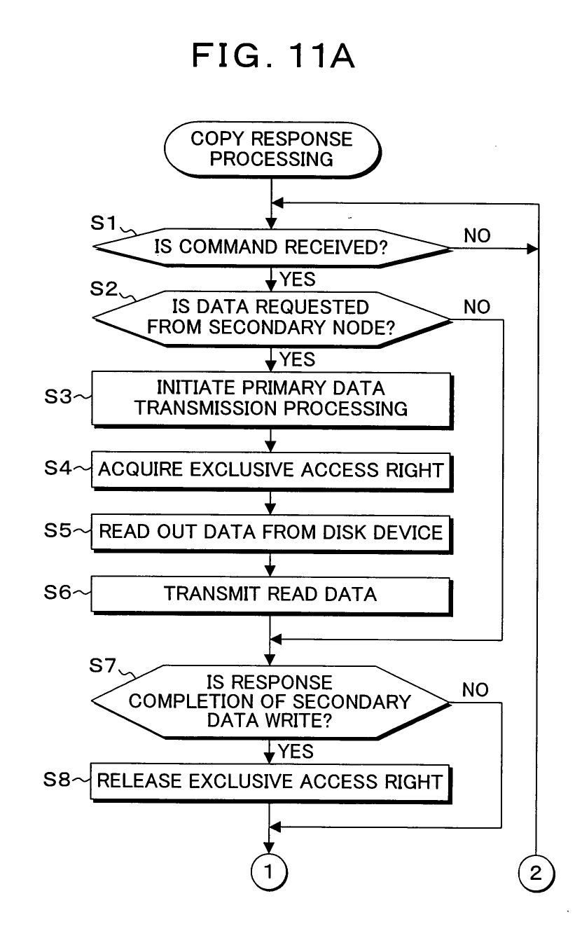

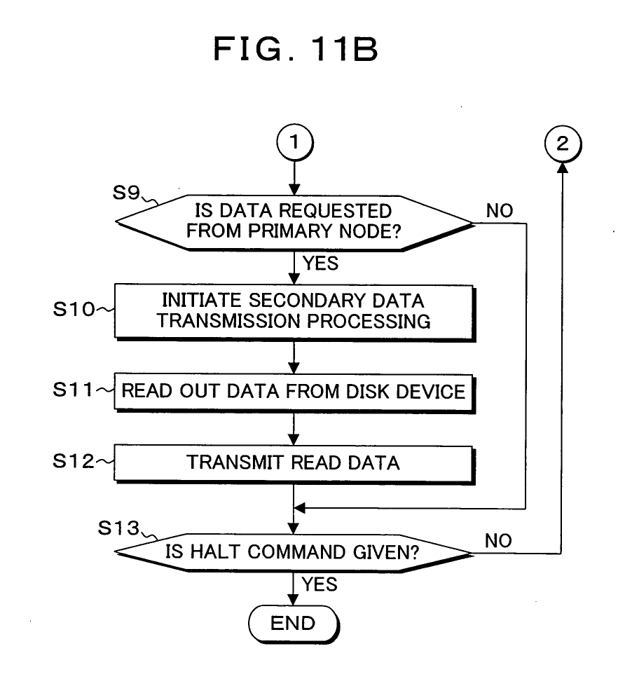

FIGS. 11A and 11B are flow charts of copy response processing in the copy response processing unit 30 provided to the node controller 24 in FIG. 6. In the copy response processing in FIGS. 11A and 11B, whether a command is received is checked at step S1, the command is decoded when it is received, and whether data is requested from the node device that stores secondary data is checked at step S2. When there is a data request from the node device that stores the secondary data, the step proceeds to step S3, followed by initiating primary data transmission processing. In this primary data transmission processing, an exclusive access right to the target disk device is acquired at step S4, and the step proceeds to step S5 in this state, followed by reading out the primary data from the disk device. The read out primary data is transmitted to the requesting source at step S6. At step S7, whether the received command is a response to the secondary data write completion is checked, and when the response is the write completion, the exclusive access right acquired at step S4 is released at step S8. At step S9, whether the contents of the received command is a data request from the node device that stores primary data is checked, and when it is the data request from the node device that stores the primary data, the step proceeds to step S10, followed by initiating secondary data transmission processing. In this secondary data transmission processing, the secondary data is read out from the target disk device at step S11, and the read secondary data is transmitted to the node of requesting source at step S12. In the read-out processing for the request for the secondary data at steps S9 to S12, no control of exclusive access right is executed. Such response processing of steps S1 to S12 is repeated until a halt command is given at step S13.

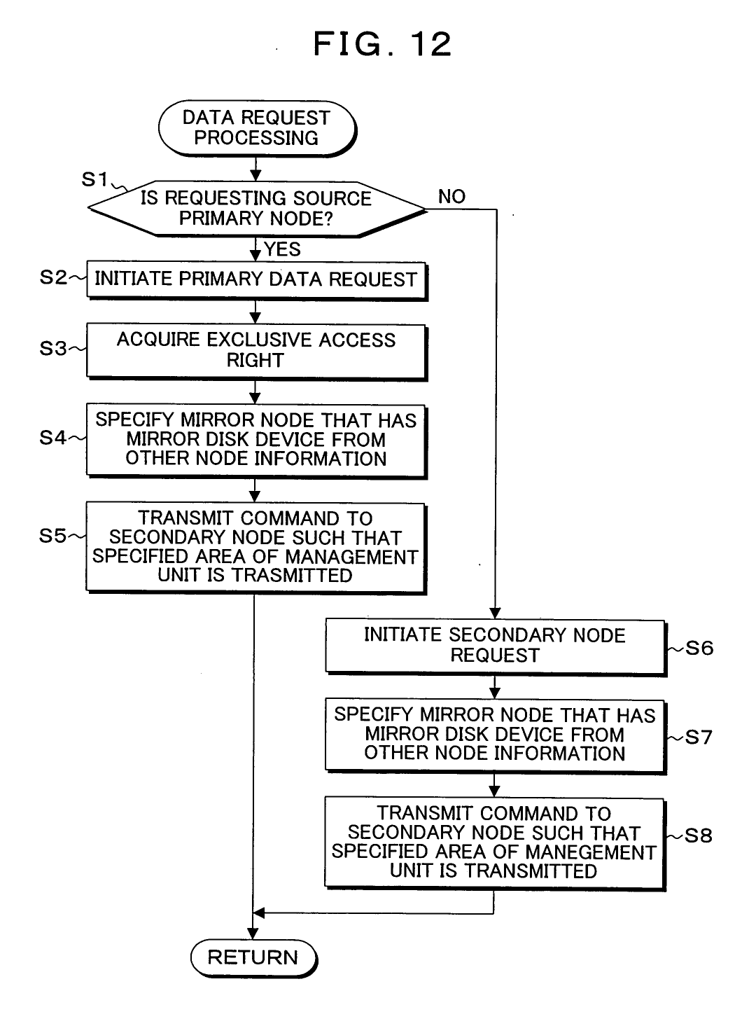

FIG. 12 is a flow chart of the data request processing at step S4 in FIG. 10. In the data request processing in FIG. 12, it is checked at step S1 whether the RAID device that serves as a requesting source of the data is a primary node storing the primary data. When it is the primary node, the step proceeds to step S2, followed by initiating primary data request processing. In the primary data request processing, after acquiring an exclusive access right to the spare disk device in which data is recovered at step S3, a mirror node that has a mirror disk device is specified from said other node information at step S4, and at step S5, a data request command to transmit the specified area of management unit is transmitted to the node of the RAID device that stores the secondary data, that is, the secondary node. On the other hand, when the requesting source is a secondary node at step S1, the secondary node request processing at step S6 is initiated. After a mirror node that has the mirror disk device is specified from said other node information at step S7, in this secondary node request processing, a command to transmit the specified area of management unit is transmitted to the secondary node at step S8. No control of exclusive access right is executed in this secondary node transmission request processing.

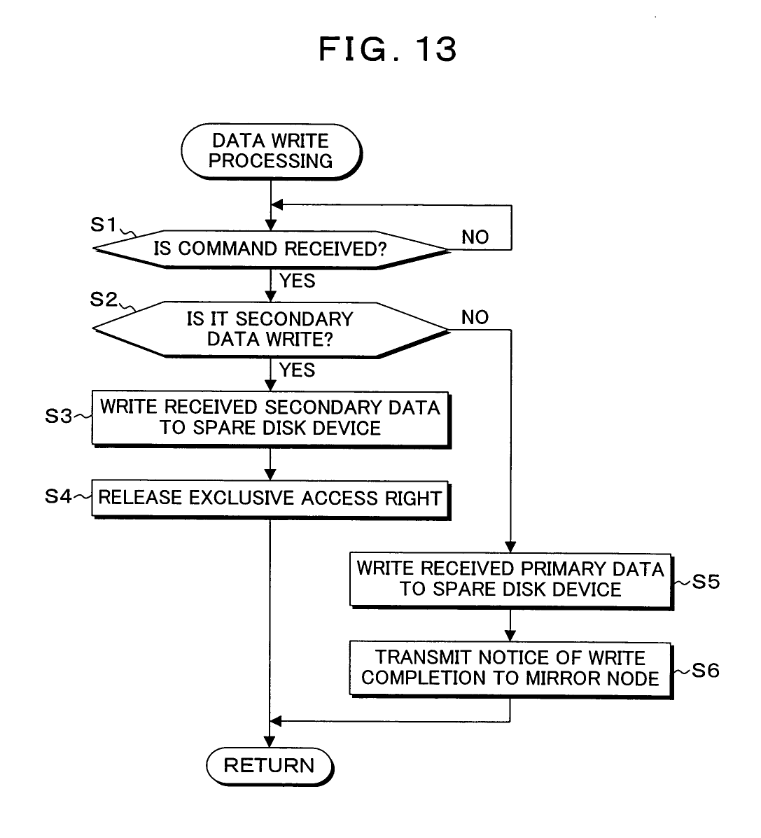

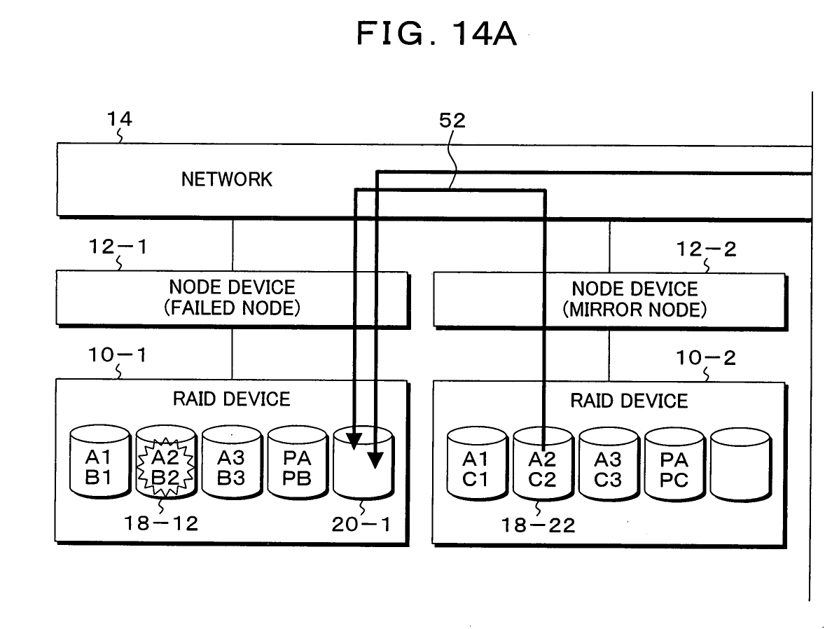

FIG. 13 is a flow chart of the data write processing at step S5 in FIG. 10. In the data write processing in FIG. 13, whether a command is received is checked at step S1, and when the command is received, it is decoded, followed by checking whether the command is to write the secondary data at step S2. When the command is to write the secondary data, the step proceeds to step S3, the received secondary data is written to the spare disk device, and the exclusive access right is released at step S4. This exclusive access right released at step S4 is the access right acquired at step S3 in FIG. 12. On the other hand, when it is recognized that the command is to write the primary data from the received command at step S2, the step proceeds to step S5. After the received primary data is written to the spare disk device, a notice of the write completion is transmitted to the mirror node at step S6. The mirror node that has received the notice of the write completion at step S6 receives a notice of the secondary data write completion at step S7 of the flow chart in FIGS. 11A and 11B, followed by releasing the exclusive access right at step S8.

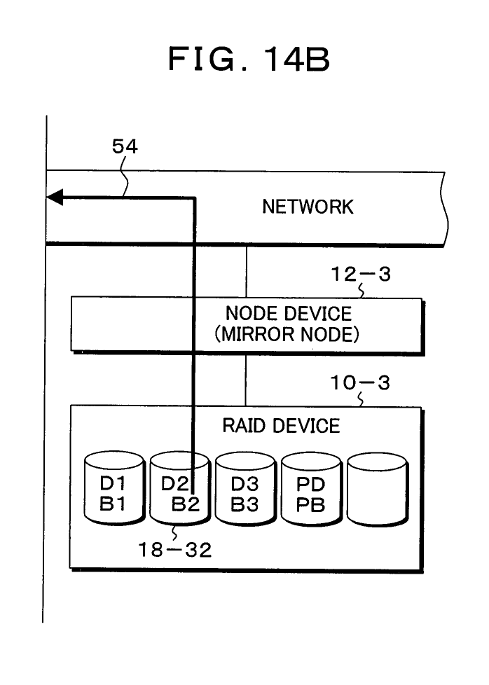

FIGS. 14A and 14B are detailed diagrams to explain recovery processing in the storage system in FIG. 5 in a case where mirror targets vary for every management unit in the RAID device. In FIGS. 14A and 14B, primary data (A1, A2, A3, and PA) are stored in every management unit in the disk devices of the RAID device 10-1, and secondary data (A1, A2, A3, and PA) are stored in the RAID device 10-2 that serves as its mirror target. Further, primary data (D1, D2, D3, and PD) are stored as management units of the RAID device 10-3, and secondary data (B1, B2, B3, and PB) are stored in the node device 12-3 that serves as its mirror target. In such a storage system where mirror targets vary for every management unit, for example, when the disk device 18-12 of the RAID device 10-1 is broken down to lead to a failure, the node device 12-1 makes a data request for every management unit, and the data is recovered in the spare disk device 20-1. In other words, as to the primary data A2 that is lost owing to the breakdown of the disk device 18-12, the secondary data A2 is read out from the disk device 18-22 of the RAID device 10-2 that serves as its mirror target, and copy transmission 52 is carried out, thereby recovering the data in the spare disk device 20-1. With respect to the primary data B2 that is another management unit of the broken down disk device 18-12, the secondary data B2 of the disk device 18-32 of the RAID device 10-3 that serves as its mirror target is read out, and copy transmission 54 is carried out, followed by recovering it in the spare disk device 20-1. The configuration of the node devices 12-1 to 12-3 and the RAID devices 10-1 to 10-3 in the case where mirror targets vary for every management unit as illustrated in FIGS. 14A and 14B are basically the same as that of embodiment in FIG. 6, but is different in the respect that the copy request processing and the copy response processing at the time of failure recovery are carried out for every management unit in the RAID device.

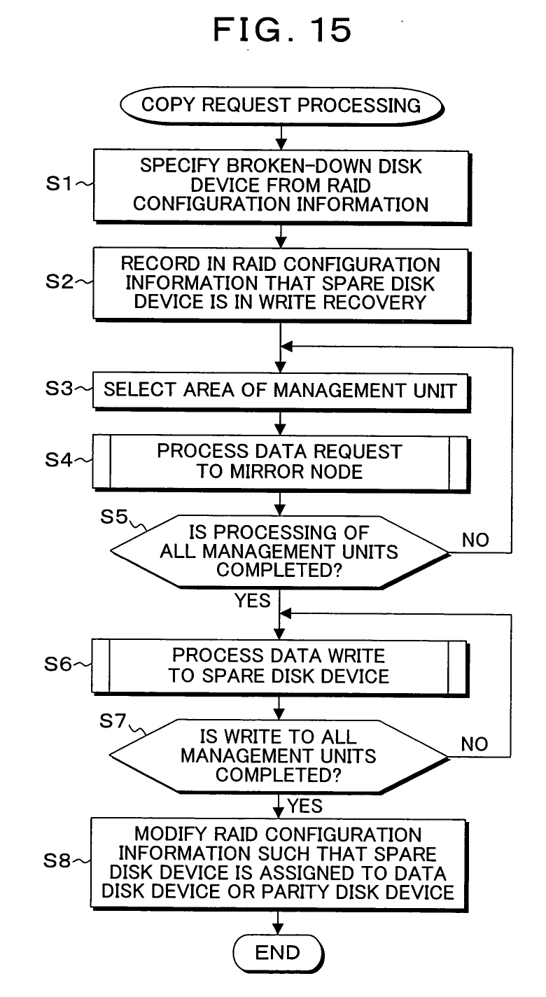

FIG. 15 is a flow chart of copy request processing in a case where mirror targets vary for every management unit of the RAID device in FIGS. 14A and 14B. Similarly to the case where all of the RAID devices in FIG. 10 are mirrored, a failure of a disk device is detected by the RAID controller 38 in the RAID device 10-1 in FIG. 6 and posted to the node controller 24 via the RAID interface 32, followed by initiation of the copy request processing in FIG. 15. At this time, the RAID controller 38 records the broken-down disk device in the RAID configuration information 40. In the copy request processing in FIG. 15, first, a broken-down disk device is specified from the RAID configuration information 40 at step S1, and it is recorded in the RAID configuration information 40 at step S2 that a spare disk device is in write recovery, and then an area of management unit in the RAID device is selected at step S3. Next, data request processing for a management unit is carried out to the mirror node selected from said other node information at step S4. Then, whether processing of all management units is completed is checked at step S5, and when it is “NO”, the processing from step S3 is repeated until the processing is completed. Since mirror targets vary for every management unit in data request processing for every management unit to a mirror node at step S4, data requests are made to different mirror nodes. When the processing for all management units is completed at step S5, the step proceeds to step S6, and the data received from the mirror node is written to a spare disk device. This write processing is repeated until write in all management units is completed at step S7. When the write is completed, the step proceeds to step S8, and the RAID configuration information is modified such that the spare disk device is assigned as a data disk device or a parity disk device, followed by completing of the series of recovery processing. The data request processing at step S4 in the copy request processing in the case where mirror targets vary for every management unit in the RAID device is the same as that in the flow chart in FIG. 12, and the data write processing at step S6 is the same as that of the flow chart in FIG. 13. Further, the copy response processing by the copy response processing unit 30 in FIG. 6 in the case where mirror targets vary for every management unit of the RAID device is the same as that of the flow chart of the copy response processing in FIGS. 11A and 11B.

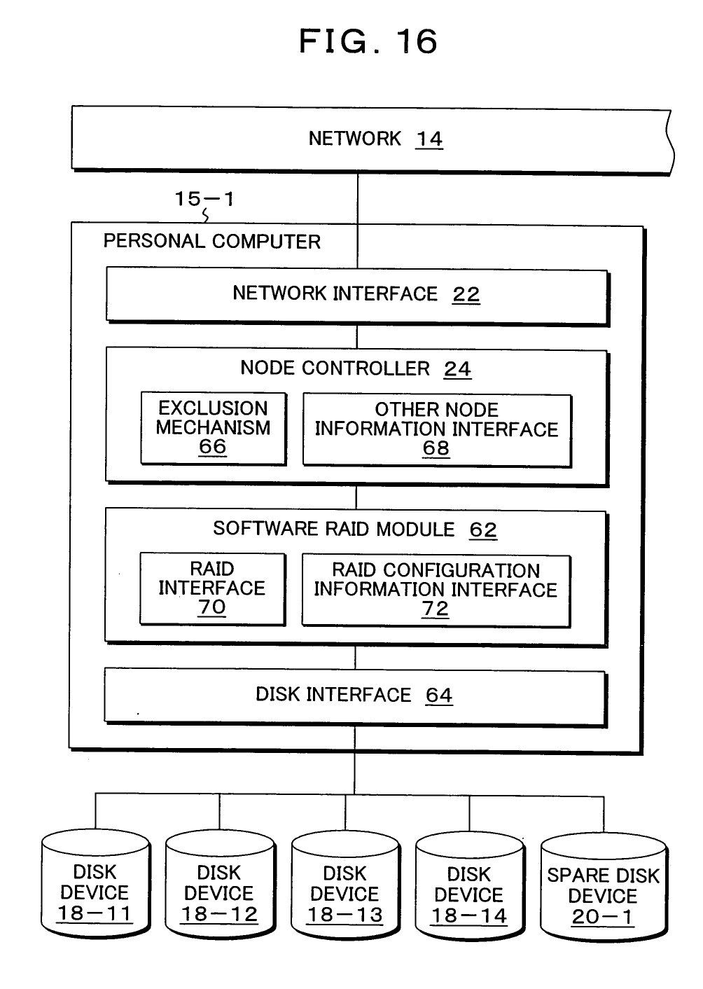

FIG. 16 represents another embodiment of node device and RAID device in the storage system of the present invention. This embodiment is characterized in that a personal computer and disk devices configure the node device and the RAID device, respectively. In FIG. 16, to the network 14 are arranged a personal computer 15-1, a plurality of disk devices 18-11 to 18-14, and the spare disk device 20-1. On the personal computer 15-1 are provided the network interface 22, the node controller 24, a software RAID module 62 and a disk interface 64. To the node controller 24 are provided an exclusion mechanism 66 and other node information interface 68. To the software RAID module 62 are provided a RAID interface 70 and a RAID configuration information interface 72. In this embodiment, the node controller 24 is realized by software of the personal computer 15-1. Further, the software RAID module 62 is a virtual driver capable of accessing via the disk interface 64 to the disk devices 18-11 to 18-14 and the spare disk device 20-1 as devices constituting RAID. The node controller 24 is capable of accessing individually to the disk devices 18-11 to 18-14 and the spare disk device 20-1 via the disk interface 64 as well as to RAID configuration with the disk devices 18-11 to 18-14 via the RAID interface 70 of the software RAID module 62. When an input and output of primary data is carried out in a case of recovery for a breakdown disk device, the node controller 24 acquires an exclusive access right to request access to individual disk devices and realizes the control function of the exclusion mechanism 66 that inhibits access to the RAID configuration by a user. Further, in this embodiment, a function of said other node information interface 68 that is used for specifying a mirror target by the function of the node controller 24 instead of retaining the node information is provided. Furthermore, in the software RAID module 62, a function that obtains RAID configuration information by the RAID configuration interface 72 instead of retaining RAID configuration information is realized.

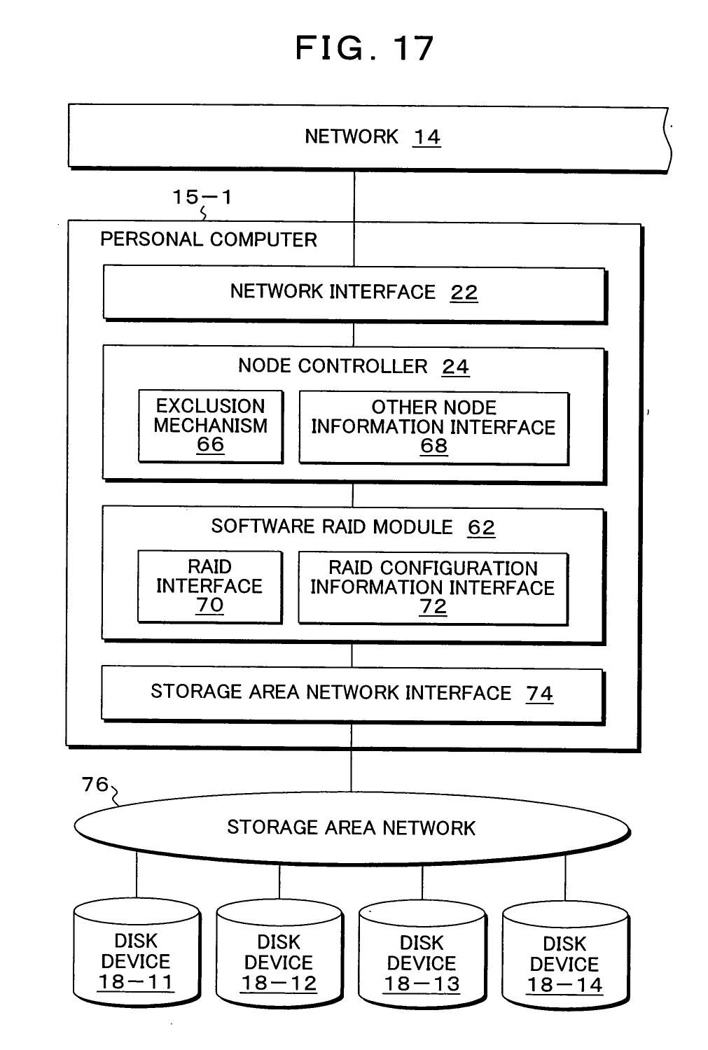

FIG. 17 is a detailed diagram to explain still another embodiment of the configuration of a node in the storage system of the present invention. This embodiment is characterized in that the node device and the RAID device are configured with the personal computer 15-1 and a storage area network (SAN) 76, respectively. In FIG. 17, the feature that the network interface 22, the node controller 24, and the software RAID module 62 are provided to the personal computer 15-1 is the same as that in the embodiment in FIG. 16; however, the disk devices 18-11 to 18-14 are configured with the use of the storage area network (SAN) 76. Accordingly, the personal computer 15-1 is provided with a storage area network interface 74. With respect to the disk devices 18-11 to 18-13 provided with the storage area network 76, a spare disk device is not necessarily connected at all times, and when any one of the disk devices is broken down and its data is recovered, a disk device may be newly connected. Further, the embodiment in FIG. 17 is exemplified by taking a case in which the disk devices of the storage area network (SAN) 76 are used; however, a network disk device that has a similar function such as iSCSI (Internet Small Computer System Interface) may also be used. Furthermore, the present invention provides a program that is used for a node having a RAID device connected to a network. This program is executed by a computer that provides a node, and the contents of the program are shown in the contents of the flow charts in FIGS. 10, 11A, 11B, 12, 13, and 15. Still further, in the hardware environment of a computer that executes the program of the present invention, RAM (random access memory), a hard disk controller (software) a floppy disk driver (software), a CD (compact disk)-ROM (read only memory) driver (software), a mouse controller, a keyboard controller, a display controller, and board for communication are connected to the bus of a CPU (central processing unit). The hard disk controller is connected to a hard disk driver and loads the program of the present invention. At the time of activation of the computer, a necessary program is invoked from the hard disk drive and extracted on the RAM (random access memory) to be executed by the CPU. It should be noted that the present invention includes appropriate modification without impairing its object and advantages, and the present invention is not limited by the numerals shown in the embodiments described above. When the characteristics of the present invention are listed, they are described in the notes below.

What is claimed is:

1. A storage system in which a plurality of RAID devices are connected to a network and data is multiplexed to primary data and secondary data by being mirrored among the RAID devices, each of the RAID devices of the storage system comprising:
a plurality of devices provided with devices constituting RAID and a spare device;
a RAID processing unit that executes request processing targeting for the device constituting RAID that store primary data for a request from a host device;
a copy request processing unit that requests data of a device corresponding to a failed device to a RAID device that is its mirror target at the time of occurrence of a device failure that can be recovered within the devices owing to the RAID configuration and writes the transferred data to the spare device for the recovery;
a copy response processing unit that reads out the data of the target device and transfers it to the requesting source upon receiving the data request from the RAID device that has the failure; and
an exclusion mechanism that exclusively controls an access right to the devices constituting RAID and an access right to individual devices.

2. The storage system according to claim 1, wherein when the failed device stores primary data, the copy request processing unit requests its secondary data to a RAID device that is its mirror target, writes the transferred secondary data to a spare device for the recovery, and
when the secondary data request is received from the RAID device that has the failure, the copy response processing unit reads out the secondary data of the target device and transfers it to the requesting source.

3. The storage system according to claim 2, wherein the exclusion mechanism acquires an exclusive access right to the spare device prior to the secondary data request by the copy request processing unit and releases the exclusive access right after the transferred secondary data is written to the spare device.

4. The storage system according to claim 1, wherein when the failed device stores secondary data, the copy request processing unit requests its primary data to a RAID device that is its mirror target, writes the transferred primary data to a spare device for the recovery, and then posts the completion of write, and
When the primary data request is received from the RAID device that has the failure, the copy response processing unit reads out the primary data of the target device and transfers it to the requesting source.

5. The storage system according to claim 4, wherein when the copy response processing unit receives the primary data request from the RAID device that has the failure, the exclusion mechanism acquires an exclusive access right to the target device for access, allows the primary data to be read out and transferred, and after the transfer, receives a notice of the completion of write from the RAID device that has the failure to release the exclusive access right.

6. The storage system according to claim 1, wherein the RAID device retains mirror configuration information that shows a RAID device that is a mirror target and RAID configuration information that shows devices constituting RAID, and
the copy request processing unit not only searches a RAID device that serves as a mirror target from the mirror configuration information but also searches a device corresponding to the failed device from the RAID configuration information to request the data at the time of a device failure.

7. The storage system according to claim 1, wherein data is multiplexed by being mirrored in all of the RAID devices.

8. The storage system according to claim 1, wherein data is multiplexed by changing a mirror target for every management unit of the RAID device.

9. The storage system according to claim 1, wherein the RAID device is connected under each of nodes that are configured with a cluster of computers connected to the network.

10. A method for processing of storage system in which a plurality of RAID devices are connected to a network and data is multiplexed to primary data and secondary data by being mirrored among the RAID devices, the method for processing of storage system comprising steps of:
RAID processing that executes request processing targeting for devices constituting RAID of a plurality of devices that store primary data for a request from a host device;
copy request processing that requests data of a device corresponding to a failed device to a RAID device that is its mirror target at the time of occurrence of a device failure that can be recovered within the devices owing to the RAID configuration and writes the transferred data to a spare device for the recovery;
copy response processing that reads out the data of the target device and transfers it to the requesting source upon receiving the data request from the RAID device that has the failure; and
exclusive control that exclusively controls an access right to the devices constituting RAID and an access right to individual devices.

11. The method according to claim 10, wherein at the copy request processing step, secondary data is requested to a RAID device that is a mirror target when the failed device stores its primary data and the transferred secondary data is written to a spare device for the recovery; and
at the copy response processing step, the secondary data of the target device is read out and transferred to the requesting source when the secondary data request is received from the RAID device that has the failure.

12. The method according to claim 11, wherein at the exclusive control step, an exclusive access right to the spare device is acquired prior to the secondary data request at the copy request processing step, and after the transferred secondary data is written to the spare device, the exclusive access right is released.

13. The method according claim 10, wherein at the copy request processing step, primary data is requested to a RAID device that is a mirror target when the failed device stores its secondary data, the transferred primary data is written to a spare device for the recovery, and then the write completion is posted; and
at the copy response processing step, the primary data is read out from the target device and transferred to the requesting source when the primary data request is received from the RAID device that has the failure.

14. The method according to claim 13, wherein at the exclusive control step, an exclusive access right to the target device for access is acquired when the primary data request is received from the RAID device that has the failure at the copy response processing step, the primary data is allowed to be read out and transferred, and after the transfer, the exclusive access right is released when a notice of the write completion is received from the RAID device that has the failure.

15. The method according to claim 10, wherein the RAID device retains mirror configuration information showing a RAID device that is a mirror target and RAID configuration information showing devices constituting RAID; and
at the copy request processing step, not only is a RAID device that is a mirror target searched from the mirror configuration information but also a device corresponding to the failed device is searched from the RAID configuration information for requesting data.

16. The method according to claim 10, wherein data is multiplexed by being mirrored in all of the RAID devices.

17. The method according to claim 10, wherein data is multiplexed by changing a mirror target for every management unit in the RAID device.

18. The method according to claim 10, wherein the RAID device is connected under each of nodes of a cluster of computers connected to the network.

19. A program for processing storage system, which a plurality of RAID devices are connected to a network, that allow data to be multiplexed to primary data and secondary data by mirroring among the RAID devices, wherein said program allows a computer to execute:
RAID processing that executes request processing targeting for devices constituting RAID of a plurality of devices that store primary data for a request from a host device;
copy request processing that requests data of a device corresponding to a failed device to a RAID device that is its mirror target at the time of occurrence of a device failure that can be recovered within the devices owing to the RAID configuration occurs and writes the transferred data to a spare device for the recovery;
copy response processing that reads out the data of the target device and transfers it to the requesting source upon receiving the data request from the RAID device that has the failure; and
exclusive control that exclusively controls an access right to the devices constituting RAID and an access right to individual devices.

20. The program according to claim 19, wherein at the copy request processing step, secondary data is requested to a RAID device that is a mirror target when the failed device stores its primary data and the transferred secondary data is written to a spare device for the recovery; and
at the copy response processing, the secondary data of the target device is read out and transferred to the requesting source when the secondary data request is received from the RAID device that has the failure.
